(19) United States
(12) Patent Application Publication
(10) Pub. No.: US 2026/0352022 A1
(43) Pub. Date: Nov. 5, 2026

(54) HIGH-EFFICIENCY ELECTROMAGNETIC TRANSDUCER

(71) Applicant: Nolan Francis Chowansky, Tampa, FL (US)

(72) Inventor: Nolan Francis Chowansky, Tampa, FL (US)

(21) Appl. No.: 19/743,420

(22) Filed: Jul. 15, 2026

Related U.S. Application Data
(63) Continuation-in-part of application No. 19/182,532, filed on Apr. 17, 2025.

(51) Int. Cl. H02J 50/10; H02J 7/34; H02N 11/00; H02N 15/00

(52) U.S. Cl. CPC H02J 50/10; H02N 11/002; H02N 15/00; H02J 7/345

(57) ABSTRACT

A magnetically levitated inductive energy storage and power transfer system includes a housing comprising one or more electrically conductive materials configured to store electrical energy and function as an electrical power source for supplying electrical output to the system and to one or more external loads. A transducer core assembly is disposed within a chamber of the housing and is configured for electromagnetic induction. One or more magnetic arrays, a magnetic levitation assembly, or one or more rotational support structures facilitate operation of the transducer core assembly. One or more energy transfer structures and directional energy-control elements regulate electrical energy transfer between the transducer core assembly and the housing. The system may further include external power interfaces, modular interconnection interfaces, environmental-control assemblies, control mechanisms, and thermal-energy harvesting elements configured to supplement electrical energy available for system operation.

### CROSS-REFERENCE TO RELATED APPLICATIONS

This application is a continuation-in-part of co-pending U.S. Non-Provisional patent application Ser. No. 19/182,532, filed Apr. 17, 2025, entitled “HIGH-EFFICIENCY ELECTROMAGNETIC TRANSDUCER,” the entire disclosure of which is hereby incorporated by reference in its entirety. This application claims the benefit of and priority to the above-identified parent application under 35 U.S.C. § 120 with respect to all subject matter disclosed therein. The present continuation-in-part further supplements the disclosure with additional descriptive detail, revised nomenclature, additional drawings, and corresponding claims to further describe and protect embodiments disclosed in the parent application. The continuation-in-part further adds new matter relating to an optional thermoelectric energy-harvesting embodiment, including a thermoelectric film and associated electrical coupling for recovering thermal energy and supplying supplemental electrical energy to the system, as described herein.

### BACKGROUND OF THE INVENTION

### Field of the Invention

The present invention relates generally to electrical energy generation, storage, transfer, and distribution systems, and more particularly to a modular, scalable, magnetically supported inductive energy storage and power transfer system with external power input capability. The system integrates electromagnetic induction, magnetic support, and an electrically conductive energy-storage housing configured to store electrical energy and function as an electrical power source for supplying electrical output. In various embodiments, the housing may function as a battery, a supercapacitor, or a hybrid battery-supercapacitor. The system is further configured to receive electrical energy from external power sources and to be interconnected with one or more additional systems to provide scalable electrical power generation, storage, and delivery.

### Description of Related Art

Conventional electrical energy generation, storage, and distribution systems, including battery-based technologies, often rely on chemical reactions for power generation and storage. Such systems may exhibit limited operational life, thermal inefficiencies, maintenance challenges, or limited serviceability once their energy-storage capacity is depleted. Many existing systems are designed primarily for a single function, such as energy generation or energy storage, and often lack integrated mechanisms configured to generate, store, and supply electrical energy within a unified architecture. In addition, many conventional systems depend upon rare-earth or other critical materials and may present environmental, manufacturing, or lifecycle challenges.

Various electromechanical, magnetic levitation, flywheel, inductive power transfer, and advanced energy-storage systems have been proposed. For example, magnetic levitation generators such as WO2016019221A1, CN102820834A, and CN202309471U disclose levitated components for electrical generation. Other references disclose vacuum chambers, advanced conductive materials, graphene-based structures, flywheel energy systems, modular energy-storage systems, or inductive power transfer arrangements. However, there remains a need for an integrated electrical energy system comprising an electrically conductive energy-storage housing configured to function as an electrical storage and power source, a magnetically supported transducer core assembly configured for electromagnetic induction and electrical energy generation, an external power input capability, and scalable interconnection of multiple systems. Accordingly, there remains a need for a modular, serviceable, and scalable electrical energy system configured to generate, store, and supply electrical energy.

### SUMMARY OF THE INVENTION

The present invention, referred to as the High-Efficiency Electromagnetic Transducer (HEET), is a modular, scalable electromagnetic energy storage, power transfer, and electrical power delivery system with external power input capability. The HEET comprises a transducer core assembly configured for electromagnetic induction and an electrically conductive housing configured to store electrical energy and function as an electrical power source. The transducer core assembly is disposed within a chamber of the housing and may be supported by a magnetic levitation assembly, one or more rotational support structures, or a combination thereof. One or more magnetic arrays, energy transfer structures, and directional energy-control elements cooperate to facilitate controlled electrical energy generation, transfer, storage, and delivery. In various embodiments, the system may receive supplemental electrical energy from one or more external power sources and may be configured for modular interconnection with one or more additional HEET systems.

An electrically conductive, lightweight, and heat-resistant structural support encloses the transducer core assembly. The structural support may comprise one or more electrically conductive materials, including graphene, carbon nanotubes, tungsten, rhenium, conductive composites, nanomaterials, or combinations thereof, and may optionally include a silicon carbide coating or other protective coating. The structural support supports and secures the magnetic arrays used for magnetic support and electromagnetic induction while providing structural integrity, thermal resistance, and electromagnetic functionality for the transducer core assembly. In certain embodiments, the magnetic arrays may comprise permanent magnets, including neodymium or other permanent magnetic materials, while the electrically conductive structural support and the housing comprise electrically conductive structural materials configured to support electrical energy storage and transfer within the system.

The system comprises one or more electrically conductive materials configured to store electrical energy and function as an electrical power source. The housing may be vacuum-sealed to reduce friction and improve operational efficiency. In preferred embodiments, the housing comprises a layered-graphene energy-storage structure configured to function as a battery, a supercapacitor, or a hybrid battery-supercapacitor, facilitating regulated electrical energy transfer with the HEET core through one or more energy transfer structures and associated directional energy-control elements. The housing is configured as a modular unit, featuring input and output interfaces to enable series, parallel, or other electrical interconnection with one or more additional HEET units, whereby electrical energy may be transferred between interconnected systems to provide scalable energy storage and power delivery. One or more external electrical ports permit connection to external electrical power sources and external electrical loads. The system may further include a power switch configured to selectively activate or deactivate system operation.

In certain embodiments, the electrically conductive housing comprises layered-graphene or a graphene-based material configured to function as a hybrid electrical energy-storage structure. In such embodiments, electrical energy may be stored electrostatically through electrochemical double-layer capacitance at the graphene surfaces and within the interlayer spaces, providing high power density and rapid charge and discharge capability, and electrochemically through Faradaic intercalation of charge carriers between graphene layers, providing increased energy density. The combination of these energy-storage mechanisms enables the housing to function as a battery, a supercapacitor, or a hybrid battery-supercapacitor capable of supplying sustained electrical output and rapid transient power while maintaining a lightweight and structurally robust configuration. The housing may receive electrical energy from one or more external power sources to replenish stored electrical energy and may supply electrical power to the transducer core assembly, one or more external electrical loads, or both. Other electrically conductive materials capable of providing equivalent or improved electrical energy-storage characteristics may be used in place of, or in combination with, graphene.

In certain embodiments, the transducer core assembly is positioned within one or more thermally insulating and electrically nonconductive support structures configured to provide mechanical support, electromagnetic isolation, thermal management, and protection during operation. The support structures may comprise high-temperature foams, ceramics, refractory materials, composite materials, or other thermally stable materials capable of maintaining structural integrity under elevated operating temperatures. In preferred embodiments, the support structures comprise synthetic silicon oxycarbide (SiOC) foam, boron nitride (BN) foam, or comparable materials providing equivalent or improved thermal and electrical insulating properties. The transducer core assembly and associated components may further be enclosed within a protective outer shell comprising one or more high-strength, heat-resistant materials configured to protect the system from thermal, mechanical, and environmental conditions. In preferred embodiments, the outer shell may comprise advanced composite materials, refractory materials, advanced ceramics, refractory metal composites, carbide-based composites, or other materials providing equivalent or superior structural and thermal performance.

The invention is adaptable for use across a broad range of electrical power applications, including portable, residential, commercial, industrial, transportation, maritime, aerospace, extraterrestrial, stationary, and mobile systems. The modular architecture enables the system to function as a standalone electrical power source or as part of an interconnected multi-unit installation. Electrical power output, energy storage capacity, and operating characteristics may be selected according to the requirements of a particular application and may be increased through changes in system configuration, materials, operating parameters, physical dimensions, or by electrically interconnecting multiple HEET systems. Accordingly, the invention is scalable from micro-scale electrical power applications to utility-scale and other large-scale electrical energy generation, storage, and power delivery systems.

The HEET provides a modular, scalable, and serviceable electrical energy system configured to generate, store, transfer, and deliver electrical energy for a wide range of applications. The system is configured to function as a standalone electrical power source or as part of an interconnected multi-unit architecture, enabling electrical energy transfer between systems to increase available power output, energy storage capacity, operational flexibility, and system redundancy. The modular construction permits inspection, maintenance, repair, replacement, and upgrading of individual components without requiring replacement of the entire system, thereby supporting extended operational life and adaptation to improved materials and technologies as they become available.

As described herein, the High-Efficiency Electromagnetic Transducer (HEET) generally comprises an electrically conductive energy-storage housing (for example, a graphene or other electrically conductive energy-storage housing), a transducer core assembly (for example, comprising a nanocrystalline magnetic core), one or more magnetic arrays, an electrically conductive structural support (for example, comprising graphene tubes or other electrically conductive structural materials), one or more magnetic support arrangements, one or more energy-transfer structures (for example, energy-transfer rods or other electrically conductive energy-transfer members), one or more directional energy-control elements (for example, diodes or other directional electrical control devices), a control system, and one or more electrical interfaces. During operation, the transducer core assembly cooperates with the magnetic arrays to produce electromagnetic induction, electrical energy is transferred through the energy-transfer structures and directional energy-control elements to the electrically conductive energy-storage housing for storage and distribution, and electrical energy may be supplied to external electrical loads through the electrical interfaces. The terminology introduced in this Summary is used consistently throughout the remainder of this specification to describe the disclosed architecture and its various embodiments.

### BRIEF DESCRIPTION OF THE DRAWINGS

FIG. 1 is a perspective view of the ruggedized housing system (100) of the High-Efficiency Electromagnetic Transducer (HEET), illustrating the exterior configuration including the housing lid (101), lid handle and latch locking mechanisms (102), LCD computing device (103), external power input connectors (104), external power output connectors (105), removable ventilation structure covers (106), LCD diagnostic screen (107), and emergency stop on/off button (108).

FIG. 2 is a cross-sectional view of the magnetically levitated HEET assembly (200), showing the ruggedized housing system (100) and the internal arrangement including the housing lid (101), the lid handle and latch locking mechanisms (102), the LCD computing device (103), the external power input connector (104), the external power output connector (105), the removable ventilation structure cover (106), the ventilation structure (211), the LCD diagnostic screen (107), the emergency stop on/off button (108), the external power source (219) and electrical conductor (201) coupled to the external power input connector (104), the core assembly (202), the core conductive winding (203), the magnetically permeable core (220), the core energy transfer structure (231) extending through the magnetically permeable core (220), the energy transfer structures (205), the directional energy-control elements (206), the wireless energy transfer regions (224) configured to transfer electrical energy through electromagnetic induction, the valve assembly (217), the chamber (232), the layered-graphene energy-storing housing (216), the electrical connection interfaces (221, 222), the electrical interconnection interface (225), the electrically conductive structural support (218) supporting the south magnetic array (207) and the north magnetic array (226), collectively forming the magnetic arrays (207, 226), the high-temperature foam buffer (208), the modular housing fasteners (210) securing adjacent housing sections of the layered-graphene energy-storing housing (216), the high-temperature structural fasteners (223) securing the electrically conductive structural support (218) to the layered-graphene energy-storing housing (216), the diagnostic sensor (230), the internal switch (229), an electrical conductor (227) electrically coupled to the internal switch (229), and an electrical conductor (228) configured to provide electrical power and communicate diagnostic information to the LCD computing device (103) and the LCD diagnostic screen (107).

FIG. 3 is a block diagram illustrating the electrical energy transfer architecture (300) of the High-Efficiency Electromagnetic Transducer (HEET), including the layered-graphene energy-storing housing (301); energy transfer rod C (302, 304), energy transfer rod D (306, 308), energy transfer rod A (310, 312), and energy transfer rod B (314, 316), which are diagrammatic representations of corresponding energy transfer structures (205); the diodes (303, 307, 311, 315), which are diagrammatic representations of corresponding directional energy-control elements (206); the wireless transmit (TX) steps (305, 313), which are diagrammatic representations of corresponding wireless energy transfer regions (224); the transducer (309), which is a diagrammatic representation of the core assembly (202); the internal switch (317), which is a diagrammatic representation of the internal switch (229); the LCD computing device with LCD diagnostic screen and power on/off control (318), which is a diagrammatic representation of the LCD computing device (103), the LCD diagnostic screen (107), and the emergency stop on/off button (108); and the optional external power source (219).

FIG. 4 illustrates the HEET electrical energy transfer and electromagnetic directional process (400), showing the unidirectional energy flow (401) through the core conductive winding (203), the magnetically permeable core (220), the core energy transfer structure (231), the energy transfer structures (205), the directional energy-control elements (206), the wireless energy transfer regions (224), the modular layered-graphene energy-storing housing panels (216) joined by interlocking joints (402, 403, 404), the energy transfer structure branch connection (405), the electrical connection interface (222), the embedded electrical connection interface (225), the electrical conductors (227, 228), the modular housing fasteners (210), the valve assembly (217), the internal switch (229), the LCD computing device (103), the LCD diagnostic screen (107), the emergency stop on/off button (108), and the opposing magnetic arrays (207, 226) configured as the magnetic support assembly.

FIG. 5 shows the HEET with the magnetic ball bearing assembly configuration (500), in which the magnetic ball bearing housings (501), the magnetic ball bearing support structures (502), and the magnetic ball bearings (503) support the core assembly (202) while being mechanically coupled to the layered-graphene energy-storing housing (216). The figure further illustrates the high-temperature fasteners (504) securing the magnetic ball bearing housings (501) to the layered-graphene energy-storing housing (216), the energy transfer structures (205), the directional energy-control elements (206), the internal switch (229), and the diagnostic sensor (230), thereby illustrating an alternative support configuration to magnetic levitation while maintaining electromagnetic induction.

FIG. 6 illustrates a cutaway side view of the magnetic ball bearing assembly (600), including the magnetic ball bearing housing (501); the multi-layered magnetic ball bearing support structure (502), including the multi-layered low-friction structure (601) and the central bore (602); the magnetic ball bearings (503); and the high-temperature fasteners (504) securing the magnetic ball bearing housing (501) to the layered-graphene energy-storing housing.

FIG. 7 is a close-up diagram (700) of the core assembly (202), illustrating the core energy transfer structure (231) extending through the magnetically permeable core, the directional energy-control elements (206), the energy transfer structures (205), the wireless energy transfer regions (224), the electrical energy flow path (702), the energy transfer structure connection point (701) electrically coupled to the layered-graphene energy-storing housing (216), and the energy transfer structure branch connection (405).

FIG. 8 illustrates one embodiment of the LCD computing device and diagnostic interface (800). In the illustrated embodiment, the LCD computing device (103) is coupled to the LCD diagnostic screen (107), which displays the diagnostic interface (801). The diagnostic interface (801) comprises system status (802), diagnostic temperature information (803), electrical energy input (804), stored electrical energy level (805), and other operational or diagnostic information associated with the High-Efficiency Electromagnetic Transducer (HEET).

FIG. 9 is a side view of the magnetic support assembly (900) configured to provide magnetic support, electromagnetic induction, and rotational operation of the core assembly (202), showing the south magnetic array (207) and the north magnetic array (226) mechanically coupled to the electrically conductive structural support (218) by one or more mechanical coupling structures (901), the electrically conductive structural support (218) secured to the layered-graphene energy-storing housing (216) by one or more high-temperature structural fasteners (223), and an integrated magnetic array (902) illustrating an alternative embodiment in which one or more magnetic arrays are integrated into the electrically conductive structural support (218).

FIG. 10 is an exterior side view of the High-Efficiency Electromagnetic Transducer (HEET) (1000) in accordance with various embodiments, illustrating the thermoelectric film (1001) mechanically and thermally coupled to the layered-graphene energy-storing housing (216). The figure further illustrates the electrical conductors (1002) electrically coupling the thermoelectric film (1001) to the external power input connector (104), the external power output connector (105), and one or more high-temperature thermoelectric film fasteners (1003) securing the thermoelectric film (1001) to the layered-graphene energy-storing housing (216).

### DETAILED DESCRIPTION OF THE INVENTION

The High-Efficiency Electromagnetic Transducer (HEET) system is a modular, scalable electrical energy generation, storage, and power supply system configured to function as an electrical power source for supplying electrical energy to the system and to one or more external electrical loads. The system integrates an electrically conductive energy-storage housing, a core assembly configured for electromagnetic induction, one or more magnetic support assemblies, one or more energy transfer structures, and one or more directional energy-control elements. These components cooperate to generate electrical energy by electromagnetic induction, transfer electrical energy to the electrically conductive energy-storage housing for storage, and supply electrical energy for operation of the system and one or more external electrical loads. In various embodiments, the electrically conductive housing functions as an electrical energy-storage structure and may operate as a battery, a supercapacitor, or a hybrid battery-supercapacitor.

Preferred embodiments utilize layered graphene or graphene-based materials to provide the electrical energy-storage functions of the housing; however, other electrically conductive materials capable of providing equivalent or superior electrical energy-storage characteristics may be used. Preferred embodiments may also employ nanocrystalline alloy cores, advanced magnetic materials, high-temperature insulating materials, and other presently preferred components, although equivalent or subsequently developed materials providing comparable or improved functional characteristics are likewise contemplated. The system is adaptable for terrestrial, maritime, aerial, extraterrestrial, stationary, mobile, portable, and large-scale electrical power applications. The following embodiments are illustrative and not limiting, and features described with respect to one embodiment may be combined with features of any other embodiment unless otherwise indicated.

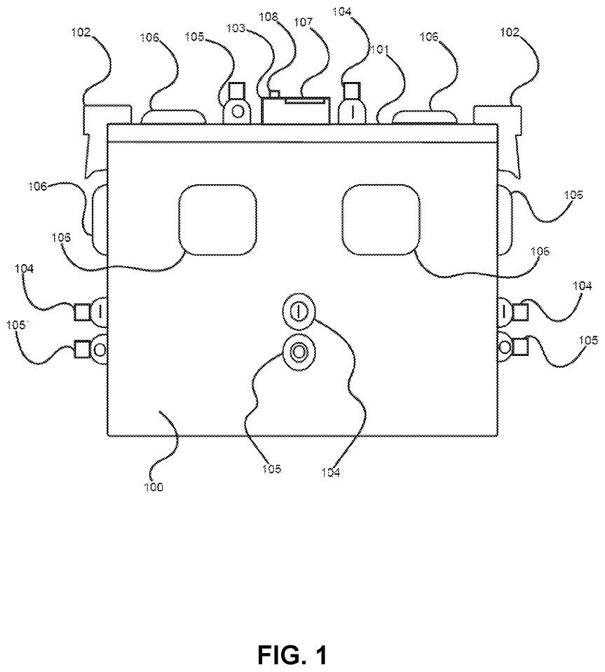

FIG. 1 illustrates one embodiment of the ruggedized housing system (100) configured to protect and support the High-Efficiency Electromagnetic Transducer (HEET) during operation in a variety of environments. The illustrated housing includes a removable housing lid (101) secured by carrying handles and latch locking mechanisms (102) that facilitate transportation, operation, maintenance, and servicing. In the illustrated embodiment, an LCD computing device (103), including an LCD diagnostic screen (107), is configured to provide operational information, including system status, electrical energy output, and diagnostic temperature information received from one or more diagnostic sensors (230), and may include an integrated emergency stop on/off button (108).

The illustrated housing further includes one or more external power input connectors (104) and one or more external power output connectors (105) configured to electrically couple the system to one or more external power sources, external electrical loads, or additional HEET systems. In the illustrated embodiment, the external power input connectors (104) and the external power output connectors (105) extend through the ruggedized housing system (100), are supported by the high-temperature foam buffer (208), and electrically engage one or more embedded electrical connection interfaces (225), which electrically couple the connectors to the layered-graphene energy-storing housing (216). The external power input connectors (104) and the external power output connectors (105) may comprise threaded connectors or other direct electrical connection configurations and may be secured to the ruggedized housing system (100) using one or more high-temperature attachment mechanisms. One or more removable ventilation structure covers (106) are configured to facilitate passive and/or active airflow through the housing and may be removable or configurable to accommodate different requirements.

Housing Lid and Locking Mechanism. The housing lid (101) provides access to the High-Efficiency Electromagnetic Transducer (HEET). The housing lid (101) is configured to engage the ruggedized housing system (100) through one or more lid handle and latch locking mechanisms (102) that maintain secure closure during transportation and operation while permitting selective removal for servicing. In the illustrated embodiment, the lid handle and latch locking mechanisms (102) are integrated with one or more carrying handles and latch locking levers. Other locking mechanisms providing equivalent or improved securement, accessibility, or environmental sealing may likewise be employed.

External power input and output capability. One or more external power input connectors (104) are configured to receive electrical energy from one or more external power sources for initial charging, supplemental charging, maintenance charging, operation, or replenishment of stored electrical energy. One or more external power output connectors (105) are configured to supply electrical energy to one or more external electrical loads, devices, systems, or additional HEET systems. The external power input connectors (104) and external power output connectors (105) may be mounted to the ruggedized housing system (100) using one or more attachment mechanisms that permit installation, servicing, replacement, or removal without substantially affecting the internal components of the system. The external power input connectors (104) and external power output connectors (105) may comprise one or more electrical connector configurations, including plug-and-socket connectors, threaded connectors, blade connectors, pin connectors, flush electrical contacts, quick-disconnect connectors, high-current electrical connectors, or other electrical connection systems capable of electrically coupling the High-Efficiency Electromagnetic Transducer (HEET) to one or more external power sources, external electrical loads, or additional HEET systems.

Ventilation and thermal management. One or more removable ventilation structure covers (106) are associated with the ruggedized housing system (100) and configured to facilitate airflow through the housing to support passive, active, or hybrid thermal management of the High-Efficiency Electromagnetic Transducer (HEET). In various embodiments, the removable ventilation structure covers (106) may comprise vents, adjustable airflow passages, or interfaces configured to receive auxiliary cooling devices, including fans, heat exchangers, thermoelectric cooling devices, or other thermal-management systems. The removable ventilation structure covers (106) may be selectively opened, closed, removed, adjusted, or reconfigured according to the operating environment and thermal requirements of the system to promote heat dissipation while maintaining the desired level of environmental protection.

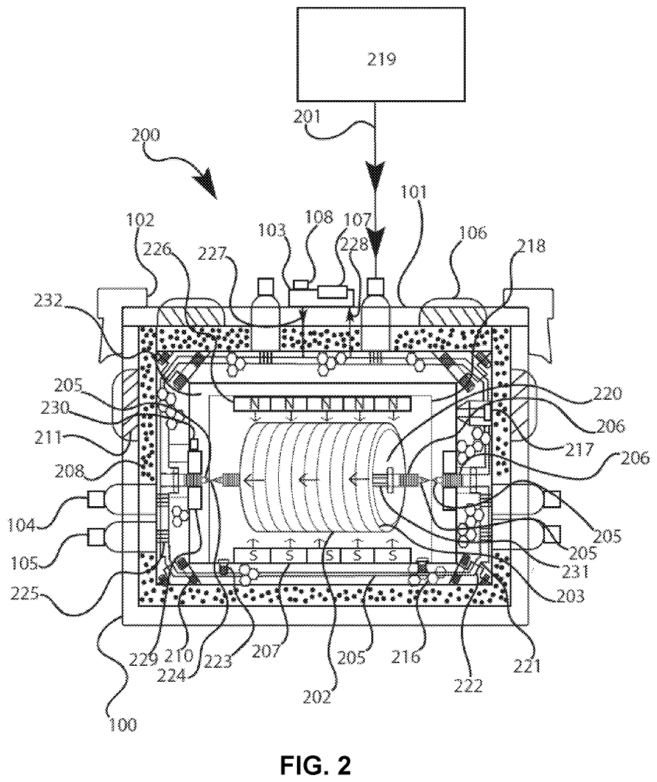

FIG. 2 provides a cross-sectional view of one embodiment of the HEET assembly (200), illustrating the internal components configured to generate, store, and supply electrical energy. The core assembly (202) comprises a transducer core assembly configured for electromagnetic induction and including a magnetically permeable core (220) and at least one core conductive winding (203). In preferred embodiments, the magnetically permeable core (220) comprises a nanocrystalline alloy or another material providing equivalent or improved electromagnetic characteristics, and the core conductive winding (203) comprises copper, silver, aluminum, conductive alloys, conductive composites, superconductive materials, or other electrically conductive materials suitable for electromagnetic induction. In certain embodiments, the core assembly (202) further comprises one or more electrically insulating materials configured to enhance electromagnetic performance, provide electrical insulation, protect the core assembly (202), and maintain structural integrity. Preferred insulating materials include aluminum nitride (AlN), advanced ceramic materials, dielectric materials, composite insulating materials, polymeric insulating materials, or other materials providing equivalent or superior insulating and thermal characteristics. A core energy transfer structure (231) extends through the magnetically permeable core (220) and is electrically coupled to one or more energy transfer structures (205), which are configured to transfer electrical energy between the core assembly (202) and the layered-graphene energy-storing housing (216). The system may receive electrical energy from one or more external power sources (219) through one or more electrical conductors (201) and external power input connectors (104) to charge the layered-graphene energy-storing housing (216), replenish stored electrical energy, or support system operation.

Magnetic support and rotational support structures. In various embodiments, the core assembly (202) is supported within the chamber (232) by one or more magnetic support assemblies configured to facilitate low-friction operation. In preferred embodiments, the core assembly (202) is magnetically supported within the chamber (232), which may comprise a vacuum-sealed environment maintained through a valve assembly (217) or other environmental-control structure.

Magnetic support is provided by one or more magnetic arrays arranged as a magnetic support assembly (900). In the illustrated embodiment, the magnetic arrays comprise a south magnetic array (207) and a north magnetic array (226) arranged relative to the core assembly (202) to generate magnetic fields that support the core assembly (202) and facilitate electromagnetic induction. The illustrated south magnetic array (207) and north magnetic array (226) are exemplary only, and the magnetic support assembly may comprise one or more magnetic arrays arranged in any suitable configuration. The magnetic arrays may comprise any suitable magnetic material, including permanent magnets, rare-earth magnets, ferrite magnets, alnico magnets, iron-nitride magnets, engineered magnetic materials, composite magnetic materials, metamaterials, or subsequently developed magnetic materials having equivalent or superior magnetic properties.

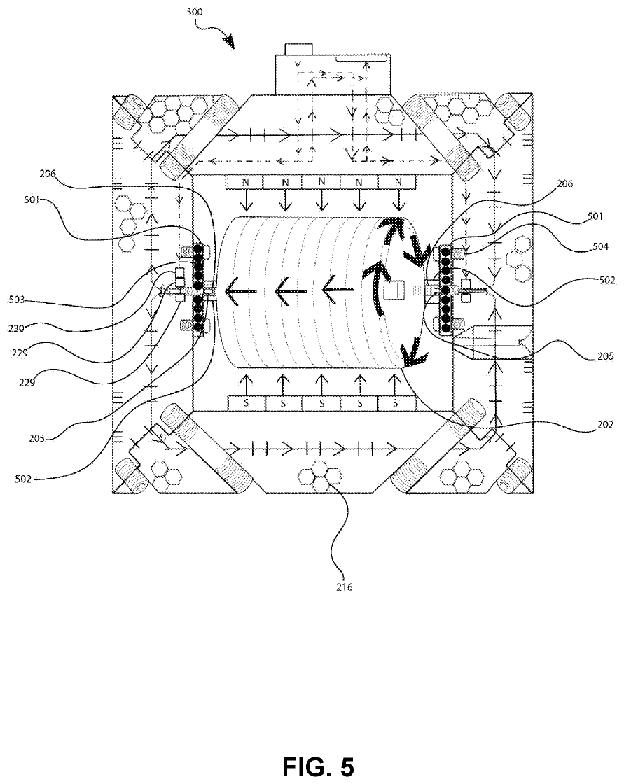

In other embodiments, one or more rotational support structures, including magnetic ball bearing housings (501) and magnetic ball bearing support structures (502), mechanically support the core assembly (202) while maintaining the electromagnetic induction architecture of the system. In these embodiments, the magnetic ball bearing assemblies are mechanically coupled to the layered-graphene energy-storing housing (216) and provide an alternative support arrangement to magnetic levitation, while the magnetic arrays (207, 226), arranged as the magnetic support assembly (900), generate the magnetic fields that facilitate electromagnetic induction during operation. Accordingly, the magnetic ball bearing embodiment provides an alternative structural support configuration without changing the electromagnetic induction operation of the disclosed system. These and other support arrangements are described further with reference to FIGS. 5, 6, and 9.

Energy transfer structures and directional energy-control element. In the illustrated embodiment, the core assembly (202) is coupled to a core energy transfer structure (231) extending through the magnetically permeable core (220), from which one or more energy transfer structures (205) extend. The energy transfer structures (205) are configured to transfer electrical energy between the core assembly (202) and the layered-graphene energy-storing housing (216). In the illustrated embodiment, the energy transfer structures (205) are shown as energy transfer rods. Directional energy-control elements (206) are integrated with or otherwise associated with the energy transfer structures (205) and are configured to regulate the direction of electrical energy flow. Opposing energy transfer structures (205) are positioned in close proximity while maintaining a non-contact separation sufficient to permit efficient electromagnetic coupling across an air gap and to accommodate rotational movement of the core assembly (202). During operation, rotation of the core assembly (202) produces a magnetic field that generates magnetic flux linking the opposing energy transfer structures (205). The changing magnetic flux induces electrical current in the opposing energy transfer structures (205) in accordance with the principles of electromagnetic induction, thereby transferring electrical energy across the wireless energy transfer regions (224). The wireless energy transfer regions (224) comprise one or more non-contact air gaps positioned between opposing energy transfer structures (205). The air gaps are dimensioned to permit unrestricted rotational movement of the core assembly (202) without physical contact, thereby reducing mechanical friction and wear while maintaining electromagnetic coupling. Electrical energy is transferred across the wireless energy transfer regions (224) by electromagnetic induction, enabling electrical energy transfer between opposing energy transfer structures (205) while the core assembly (202) rotates. In embodiments employing magnetic support, the non-contact relationship further contributes to stable rotational operation of the core assembly (202). In preferred embodiments, the energy transfer structures (205) are electrically coupled to the layered-graphene energy-storing housing (216) through one or more energy transfer structure branch connections (405), thereby distributing electrical energy throughout the electrically conductive energy-storage structure. The layered-graphene energy-storing housing (216) may be configured to function as a battery, a supercapacitor, or a hybrid battery-supercapacitor through one or more electrical energy-storage mechanisms. Other electrically conductive materials capable of providing equivalent or superior electrical energy-storage characteristics may likewise be employed while maintaining the principles of operation described herein.

The layered-graphene energy-storing housing (216) is configured to store and supply electrical energy for operation of the High-Efficiency Electromagnetic Transducer (HEET) and for delivery to one or more external electrical loads. In preferred embodiments, the layered-graphene energy-storing housing (216) comprises layered-graphene or a graphene-based composite material configured to function as a battery, a supercapacitor, or a hybrid battery-supercapacitor, thereby providing both high electrical energy density for sustained electrical energy output and high power density for rapid charge and discharge operation. Other electrically conductive materials capable of providing equivalent or superior electrical energy-storage and electrical power-delivery characteristics may likewise be employed. The layered-graphene energy-storing housing (216) further comprises electrical connection interfaces (221, 222) configured to establish electrical continuity between adjacent modular housing sections. In the illustrated embodiment, the electrical connection interface (221) comprises a male connector and the electrical connection interface (222) comprises a corresponding female connector. When adjacent housing sections are joined, the electrical connection interfaces (221, 222) electrically engage one another to permit electrical energy to pass through the interconnected layered-graphene energy-storing housing panels (216). Other complementary electrical connection arrangements, including flush electrical contacts, spring contacts, conductive pads, plug-and-socket connectors, edge connectors, blade connectors, pin connectors, magnetic electrical connectors, or other electrical coupling structures capable of establishing electrical continuity between adjacent housing sections may likewise be employed.

In the illustrated embodiment, the layered-graphene energy-storing housing (216) is electrically coupled to one or more energy transfer structures (205) and associated directional energy-control elements (206) through one or more energy transfer structure branch connections (405) to facilitate controlled electrical energy transfer between the core assembly (202) and the layered-graphene energy-storing housing (216). The illustrated layered-graphene energy-storing housing (216) further comprises interlocking joints (402, 403, 404) secured by modular housing fasteners (210), including tungsten fasteners or other thermally resistant fastening mechanisms, configured to mechanically couple adjacent modular housing sections. Modular housing fasteners (210) provide structural integrity, modularity, serviceability, and ease of assembly.

Supercapacitor mechanism (capacitive electrical energy storage). In preferred embodiments in which the layered-graphene energy-storing housing (216) comprises layered-graphene or a graphene-based material, electrical energy is stored through one or more capacitive electrical energy-storage mechanisms. When the layered-graphene energy-storing housing (216) is charged, electrolyte ions or other charge carriers may adsorb onto the graphene surfaces and within the interlayer spaces, forming electrochemical double-layer regions at conductive interfaces. Electrical energy is thereby stored electrostatically through physical charge separation rather than solely through chemical reactions. This mechanism may facilitate rapid charging and discharging, high power density, extended life cycle, and minimal degradation. The layered-graphene structure maximizes the available conductive surface area while maintaining the structural integrity of the layered-graphene energy-storing housing (216). Other electrically conductive materials capable of providing equivalent or superior capacitive electrical energy-storage characteristics may likewise be employed while utilizing the principles described herein.

Battery mechanism (Faradaic and electrochemical charge storage). In preferred embodiments in which the layered-graphene energy-storing housing (216) comprises layered-graphene or a graphene-based material, the layered-graphene energy-storing housing (216) further functions as a battery through one or more electrochemical charge-storage mechanisms. In such embodiments, lithium ions, sodium ions, or other charge carriers may intercalate between graphene layers or participate in reversible Faradaic reactions at defect sites, edge planes, or other electrochemically active regions of the graphene structure. These electrochemical charge-storage mechanisms provide increased electrical energy density while complementing the capacitive electrical energy-storage mechanisms described above.

In the illustrated embodiment, the layered-graphene energy-storing housing (216) comprises interconnected structural panels joined by interlocking joints (402, 403, 404), which provide structural integrity while establishing electrically conductive pathways and internal layered regions that facilitate efficient charge transport, ion intercalation, and de-intercalation during charging and discharging. Other electrically conductive materials capable of providing equivalent or superior electrochemical electrical energy-storage characteristics may likewise be employed while utilizing the principles described herein.

Hybrid energy storage and power delivery. In preferred embodiments in which the layered-graphene energy-storing housing (216) comprises layered-graphene or a graphene-based material, the layered-graphene energy-storing housing (216) functions as a hybrid battery-supercapacitor by combining capacitive electrical energy-storage mechanisms with electrochemical charge-storage mechanisms. During operation, electrical energy received from the core assembly (202) through the core energy transfer structure (231), the energy transfer structures (205), and the directional energy-control elements (206) is transferred to the layered-graphene energy-storing housing (216), where the electrical energy is stored and supplied for operation of the system or to one or more external electrical loads. Capacitive electrical energy-storage mechanisms may provide rapid charge and discharge capability and high power density for transient electrical demands, while electrochemical charge-storage mechanisms provide increased electrical energy density for sustained electrical energy output. Electrical energy may also be received from one or more external power input connectors (104) to replenish stored electrical energy and supplement system operation.

The layered-graphene energy-storing housing (216) is electrically coupled to the core assembly (202) through the core energy transfer structure (231), the energy transfer structures (205), the energy transfer structure branch connections (405), and the directional energy-control elements (206), enabling controlled electrical energy transfer and storage within the system while maintaining regulated directional electrical energy flow. In preferred embodiments, the layered-graphene energy-storing housing (216) is configured to store electrical energy received through the disclosed electrical energy-transfer architecture and to supply stored electrical energy for operation of the system and one or more external electrical loads. Other electrically conductive materials capable of providing equivalent or superior electrical energy-storage and electrical power-delivery characteristics may likewise be employed while utilizing the principles described herein.

Housing structure and thermal buffering. In various embodiments, the layered-graphene energy-storing housing (216) comprises one or more structural, electrically insulating, and thermal-management layers configured to provide mechanical support, electrical isolation, thermal regulation, and environmental protection for the internal components of the High-Efficiency Electromagnetic Transducer (HEET). A thermal buffer (208) is disposed between the High-Efficiency Electromagnetic Transducer (HEET) assembly (200, 500) and the ruggedized housing system (100), the thermal buffer (208) being configured to reduce heat transfer, thermally isolate the HEET assembly, protect adjacent components, and maintain stable operating conditions during operation. In preferred embodiments, the thermal buffer (208) may comprise boron nitride (BN) foam, synthetic silicon oxycarbide (SiOC) foam, or other thermally insulating materials capable of providing equivalent or superior thermal, electrical insulating, and mechanical characteristics. The ruggedized housing system (100) provides environmental protection, impact resistance, and structural support for the removable HEET assembly.

One or more ventilation structures (211) are associated with the ruggedized housing system (100) to facilitate airflow and thermal management. In the illustrated embodiment, one or more removable ventilation structure covers (106) selectively cover the ventilation structures (211) while permitting access or installation of passive, active, or hybrid thermal-management systems. The ventilation structures (211) may comprise vents, airflow passages, ducts, or other airflow interfaces configured to facilitate environmental control and heat dissipation. In preferred embodiments, the thermal buffer structures (208) are capable of maintaining structural, thermal, and electrical insulating characteristics at high temperatures.

Vacuum sealing valve. In embodiments employing a vacuum environment, the chamber (232) may be maintained at a reduced pressure by one or more valve assemblies (217) configured to establish, maintain, or regulate the internal operating environment of the chamber (232). In the illustrated embodiment, the valve assembly (217) comprises a spring-free, all-metal angle valve or a functionally equivalent valve configured to provide a reliable vacuum seal while minimizing outgassing and particulate generation. Preferred embodiments may utilize a single-crystal tungsten knife-edge seal engaging a high-conductivity metal gasket, including a silver-plated oxygen-free high-conductivity (OFHC) copper gasket, or another metal-to-metal sealing arrangement providing equivalent or superior sealing characteristics. The valve assembly (217) may further comprise heat-resistant structural materials, including ESR 316LN stainless steel or equivalent materials, and may include a 316L stainless steel bellows together with a sapphire-tipped, tungsten-coated poppet actuated by samarium-cobalt magnets or other magnetic actuation structures. In preferred embodiments, the valve assembly (217) is configured to operate at elevated temperatures and may be coupled to the chamber (232) or the ruggedized housing system (100) through one or more vacuum-compatible connection interfaces, including ConFlat (CF) flanges or functionally equivalent vacuum sealing interfaces.

User interface and system control. In the illustrated embodiment, the High-Efficiency Electromagnetic Transducer (HEET) includes an LCD computing device (103) mounted to the housing lid (101) and configured to provide operational information and receive user input. The LCD computing device (103) comprises an LCD diagnostic screen (107) configured to present a diagnostic interface (801) comprising temperature information (802), electrical energy input (803), electrical energy output (804), stored electrical energy level (805), and other system diagnostic information. The LCD computing device (103) further includes an integrated emergency stop on/off button (108) configured to selectively activate, deactivate, or interrupt operation of the High-Efficiency Electromagnetic Transducer (HEET).

In the illustrated embodiment, the LCD computing device (103) is electrically coupled through one or more electrical conductors (227, 228) to one or more internal switches (229), one or more diagnostic sensors (230), and other system components, with at least a portion of the electrical conductors (227, 228) routed along or adjacent to the energy transfer structures (205). Electrical conductor (227) is electrically coupled to the internal switch (229), and electrical conductor (228) is electrically coupled to the LCD computing device (103) and LCD diagnostic screen (107) to provide electrical power and communicate diagnostic information. Removal of the housing lid (101) permits access to the HEET and, in preferred embodiments, actuates one or more safety mechanisms configured to interrupt system operation. Although the illustrated embodiment utilizes an LCD computing device (103), other user-interface technologies capable of providing operational information and receiving user input may likewise be employed.

Carrying handles, lid securement, and electrical connectors. The carrying handles and lid handle and latch locking mechanisms (102) are configured to secure the housing lid (101) to the ruggedized housing system (100) and provide grip points for transportation, installation, and servicing of the High-Efficiency Electromagnetic Transducer (HEET). The illustrated housing further includes one or more external power input connectors (104) and one or more external power output connectors (105) configured to electrically couple the system to one or more external power sources, external electrical loads, or additional HEET systems. In the illustrated embodiment, the external power input connectors (104) and the external power output connectors (105) extend through the ruggedized housing system (100), are supported by the high-temperature foam buffer (208), and electrically engage one or more embedded electrical connection interfaces (225), which electrically couple the connectors to the layered-graphene energy-storing housing (216). The external power input connectors (104) and the external power output connectors (105) may comprise threaded connectors or other direct electrical connection configurations and may be secured to the ruggedized housing system (100) using one or more high-temperature attachment mechanisms while utilizing the principles described herein.

The layered-graphene energy-storing housing (216) further comprises one or more electrical connection interfaces (225) embedded within the layered-graphene energy-storing housing (216). The electrical connection interfaces (225) electrically couple the external power input connector (104) and the external power output connector (105) to the electrically conductive structure of the layered-graphene energy-storing housing (216). Electrical energy received through the external power input connector (104) is conducted through the electrical connection interfaces (225) to the layered-graphene energy-storing housing (216) for charging or system operation, and electrical energy stored within the layered-graphene energy-storing housing (216) is conducted through the electrical connection interfaces (225) to the external power output connector (105) for delivery to one or more external electrical loads.

Electrically conductive structural support. The core assembly (202) is associated with an electrically conductive structural support (218) configured to support the core assembly (202), maintain the positional relationship of one or more magnetic arrays (207, 226) arranged as the magnetic support assembly (900), and provide structural integrity during operation. In the illustrated embodiment, the electrically conductive structural support (218) comprises a cage formed from one or more electrically conductive structural materials. Preferred embodiments may comprise graphene, graphene-based materials, carbon nanotubes, conductive metals, conductive alloys, tungsten, rhenium, conductive composite materials, nanomaterials, or other electrically conductive structural materials, optionally including one or more protective coatings, such as silicon carbide, or other materials providing equivalent or superior thermal, electrical, and structural characteristics. The electrically conductive structural support (218) is mechanically secured to the layered-graphene energy-storing housing (216) by one or more high-temperature structural fasteners (223). In the illustrated embodiment, the high-temperature structural fasteners (223) may comprise high-temperature screws or other thermally resistant fastening mechanisms capable of mechanically securing the electrically conductive structural support (218) to the layered-graphene energy-storing housing (216).

The electrically conductive structural support (218) is configured to support the magnetic arrays (207, 226) while withstanding elevated operating temperatures and facilitating electromagnetic operation of the High-Efficiency Electromagnetic Transducer (HEET). The magnetic arrays (207, 226), arranged as the magnetic support assembly (900), may comprise any suitable magnetic material, including permanent magnets, rare-earth magnets, ferrite magnets, alnico magnets, iron-nitride magnets, engineered magnetic materials, composite magnetic materials, metamaterials, and subsequently developed magnetic materials having equivalent or superior magnetic properties, and are configured to generate magnetic fields for magnetic support, electromagnetic induction, or both.

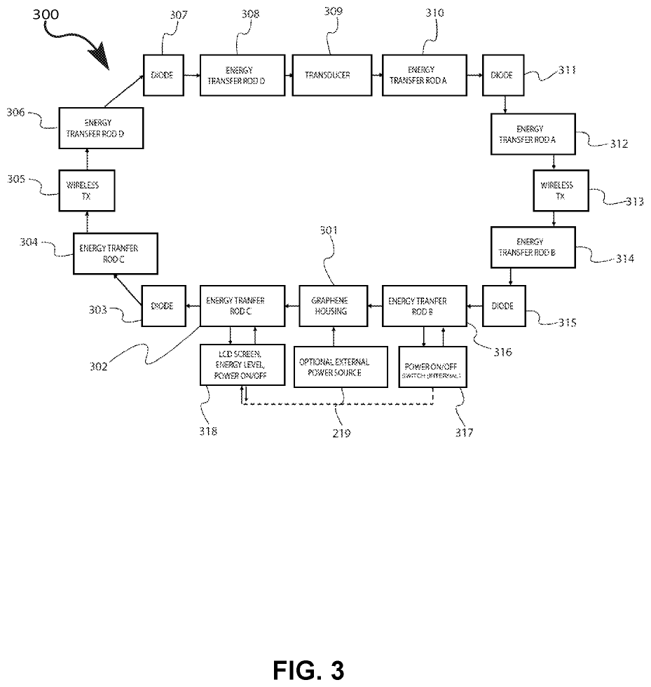

FIG. 3 is a block diagram illustrating the electrical energy transfer architecture (300) of the High-Efficiency Electromagnetic Transducer (HEET). The diagram is a functional representation provided to illustrate, in a straightforward step-by-step sequence, the internal electrical energy transfer architecture of the HEET and to demonstrate to one of ordinary skill in the art the manner in which electrical energy is transferred within the system during operation. The diagrammatic nomenclature and reference numerals used in FIG. 3 differ from those used in the structural figures to illustrate the sequential electrical energy transfer process. Accordingly, the layered-graphene energy-storing housing (301) represents the layered-graphene energy-storing housing (216); energy transfer rod C (302, 304), energy transfer rod D (306, 308), energy transfer rod A (310, 312), and energy transfer rod B (314, 316) represent corresponding energy transfer structures (205); the diodes (303, 307, 311, 315) represent corresponding directional energy-control elements (206); the wireless transmit (TX) steps (305, 313) represent corresponding wireless energy transfer regions (224); the transducer (309) represents the core assembly (202); the internal power on/off switch (317) represents the internal switch (229); and the LCD screen, energy level, and power on/off control (318) are diagrammatic representations of the LCD computing device (103), the LCD diagnostic screen (107), and the emergency stop on/off button (108). The optional external power source (219) is shown separately to illustrate an optional source of initial charging, supplemental charging, maintenance charging, or accelerated charging of the layered-graphene energy-storing housing (301, 216).

An external power source (219) provides initial charging, supplemental charging, maintenance charging, or operational electrical energy input to the layered-graphene energy-storing housing (301, 216). Electrical energy is transferred through a first energy transfer rod C (302), a first diode (303, 206), and a corresponding energy transfer rod C (304), and is transmitted across the wireless transmit (TX) step (305, 224) by electromagnetic induction to a corresponding energy transfer rod D (306). A diode (307, 206) regulates the direction of electrical energy flow to a corresponding energy transfer rod D (308), which supplies electrical energy to the transducer (309) known as the core assembly (202). Electrical energy is subsequently transferred through a second energy transfer rod A (310), a diode (311, 206), and a corresponding energy transfer rod A (312), and is transmitted across the wireless transmit (TX) step (313, 224) by electromagnetic induction to a corresponding energy transfer rod B (314). A diode (315, 206) regulates the direction of electrical energy flow to a corresponding energy transfer rod B (316), returning electrical energy to the layered-graphene energy-storing housing (301, 216) and completing the electrical energy transfer path. Electrical energy received from the external power source (219) is supplied to the layered-graphene energy-storing housing (301, 216) to charge or supplement stored electrical energy and to support operation of the High-Efficiency Electromagnetic Transducer (HEET), while enabling electrical energy to be supplied to one or more external electrical loads.

User interface and system control. In the illustrated embodiment, the LCD computing device (318, 103), including the LCD diagnostic screen (107, 801), is electrically coupled to the High-Efficiency Electromagnetic Transducer (HEET) through one or more electrical conductors (227, 228) operatively associated with the energy transfer structures (205). The LCD computing device (318, 103) is configured to present, on the LCD display screen (107), a diagnostic interface (801) comprising temperature information (802), electrical energy input (803), electrical energy output (804), stored electrical energy level (805), and other operational diagnostics associated with the electrical energy transfer architecture. The emergency stop on/off button (108) is electrically coupled through one or more internal switches (317, 229) to selectively activate, deactivate, or interrupt operation of the core assembly (202) and the associated electrical energy transfer path. Accordingly, the LCD computing device (318, 103) functions as an integrated monitoring and control interface within the electrical energy transfer architecture, permitting user interaction while remaining electrically coupled to the system through the electrical conductors (227, 228). Although the illustrated embodiment utilizes an LCD computing device, other user-interface technologies capable of monitoring system operation and providing user control may likewise be employed while utilizing the principles described herein.

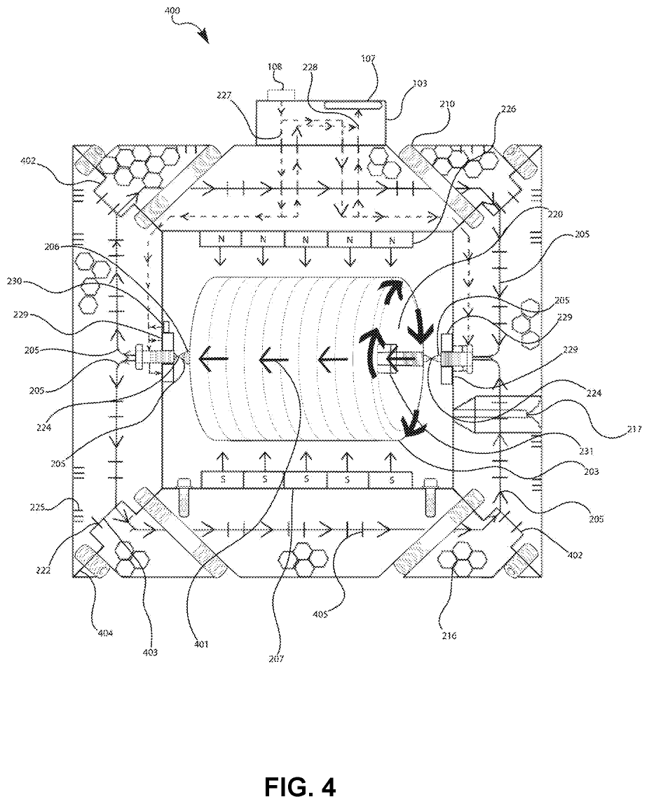

FIG. 4 illustrates one embodiment of the HEET electrical energy transfer and electromagnetic directional process (400). In the illustrated embodiment, the core energy transfer structure (231) extends through the core winding (203), with the magnetically permeable core (220), illustrated as a nanocrystalline alloy core, associated with the core winding (203), the core winding (203) and the magnetically permeable core (220) collectively cooperating to form the transducer core assembly (202). Arrows illustrate the unidirectional energy flow (401) and the corresponding magnetic flux generated during operation. The directional energy-control elements (206) regulate the direction of electrical energy flow through the energy transfer structures (205). Electrical energy is transferred across the wireless energy transfer regions (224) by electromagnetic induction through the energy transfer structures (205), thereby establishing a controlled electrical energy transfer pathway between the transducer core assembly (202) and the layered-graphene energy-storing housing (216). In the illustrated embodiment, the layered-graphene energy-storing housing (216) comprises modular panels joined by interlocking joints (402, 403, 404). The modular panel architecture facilitates inspection, maintenance, repair, replacement, and modular expansion of the layered-graphene energy-storing housing.

In the illustrated embodiment, the interlocking joints comprise a tongue (402), a corresponding groove (403), and one or more mitered corner interfaces (404) configured to mechanically interlock adjacent modular housing panels of the layered-graphene energy-storing housing (216). The tongue-and-groove configuration illustrated in FIG. 4 is provided as one exemplary interlocking arrangement. Other mechanical interlocking configurations, including dovetail joints, lap joints, keyed joints, spline joints, mortise-and-tenon joints, stepped joints, rabbet joints, mechanical locking profiles, or other complementary interlocking structures capable of mechanically coupling adjacent housing panels while maintaining electrical continuity may likewise be employed while utilizing the principles described herein.

Electrical continuity across the interlocking joints (402, 403, 404) is maintained through complementary electrical connection interfaces (221, 222), which electrically couple adjacent housing sections to establish electrical continuity between the layered-graphene energy-storing housing panels (216). The electrical conductors (227, 228) are electrically coupled across adjacent housing sections to facilitate electrical energy transfer through the interconnected layered-graphene energy-storing housing (216). In the illustrated embodiment, the first electrical connection interface (221) comprises a male connector and the second electrical connection interface (222) comprises a corresponding female connector. Other complementary electrical connection arrangements, including flush electrical contacts, spring contacts, conductive pads, plug-and-socket connectors, edge connectors, blade connectors, pin connectors, magnetic electrical connectors, or other electrical coupling structures capable of establishing electrical continuity between adjacent housing panels may likewise be employed while utilizing the principles described herein.

The energy transfer structure branch connections (405) electrically couple the energy transfer structures (205) to the layered-graphene energy-storing housing (216) to distribute electrical energy throughout the electrically conductive energy-storage structure. The layered-graphene energy-storing housing (216) is secured using modular housing fasteners (210), including tungsten fasteners or other thermally resistant fastening mechanisms, to provide a modular, serviceable housing structure. The illustrated magnetic arrays (207, 226), arranged as the magnetic support assembly (900), generate magnetic fields configured to facilitate magnetic support and electromagnetic induction, thereby establishing a dual-polarity magnetic flux path through the magnetically permeable core (220). One or more internal switches (229), diagnostic sensors (230), and electrical conductors (227, 228) are electrically coupled to the LCD computing device (103), including the LCD diagnostic screen (107) and the emergency stop on/off button (108), to monitor and control operation of the High-Efficiency Electromagnetic Transducer (HEET).

FIG. 5 illustrates one embodiment of the High-Efficiency Electromagnetic Transducer (HEET) employing a magnetic ball bearing assembly configuration (500), which provides an alternative rotational support arrangement to magnetic levitation. In the illustrated embodiment, a magnetic ball bearing housing (501) supports a magnetic ball bearing support structure (502) configured to receive the core energy transfer structure (231), the energy transfer structures (205), and the directional energy-control elements (206). A plurality of magnetic ball bearings (503) are disposed within the magnetic ball bearing housing (501) and configured to facilitate low-friction rotational support of the core assembly (202) while maintaining the positional relationship of the core energy transfer structure (231) and the energy transfer structures (205). The magnetic ball bearing housing (501) is mechanically coupled to the layered-graphene energy-storing housing (216) using one or more high-temperature fasteners (504), including tungsten fasteners or other thermally resistant fastening mechanisms. In this embodiment, the magnetic ball bearing assembly provides an alternative mechanical support arrangement while the magnetic arrays (207, 226) generate the magnetic fields that facilitate electromagnetic induction during operation. One or more diagnostic sensors (230) may be positioned within or associated with the layered-graphene energy-storing housing (216) to monitor system operating conditions, and one or more internal switches (229), including an emergency stop function, may be incorporated to facilitate safe operation and maintenance.

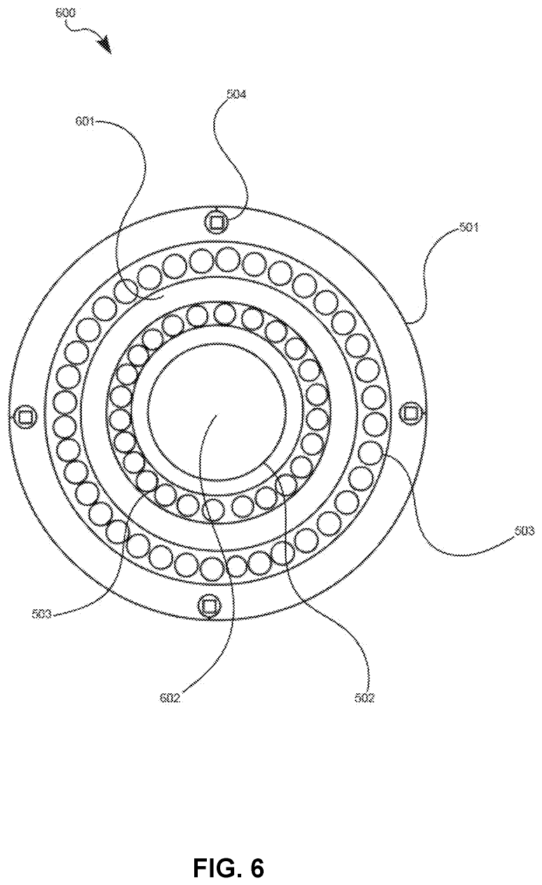

FIG. 6 is a cutaway side view of the magnetic ball bearing assembly (600) of one embodiment of the magnetic ball bearing assembly configuration. The magnetic ball bearing housing (501) is illustrated as being mechanically coupled to the layered-graphene energy-storing housing (216). In the illustrated embodiment, the magnetic ball bearing housing (501) is secured to the layered-graphene energy-storing housing (216) using high-temperature fasteners (504), including tungsten fasteners or other thermally resistant fastening mechanisms. The magnetic ball bearing support structure (502) comprises a multi-layered low-friction structure (601) configured to facilitate low-friction rotational operation. A central bore (602) of the magnetic ball bearing support structure (502) is configured to receive the core energy transfer structure (231), from which one or more energy transfer structures (205) extend. The magnetic ball bearing support structure (502) is configured to remain rotatably supported relative to the core energy transfer structure (231), permitting a plurality of magnetic ball bearings (503) disposed within the magnetic ball bearing housing (501) to rotate freely while providing controlled rotational support for the core assembly (202) without substantially affecting the electromagnetic induction operation of the High-Efficiency Electromagnetic Transducer (HEET).

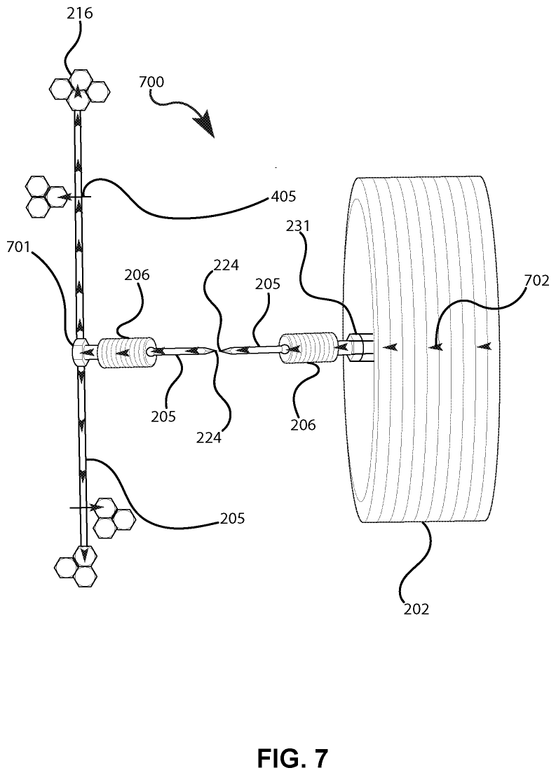

FIG. 7 is an enlarged view (700) illustrating one embodiment of the electrical energy transfer architecture, including the core energy transfer structure (231), the energy transfer structures (205), the directional energy-control elements (206), the wireless energy transfer region (224), the electrical energy flow path (702), the energy transfer structure connection point (701), and the energy transfer structure branch connection (405). During operation, electrical energy generated by electromagnetic induction within the core assembly (202) is transferred through the core energy transfer structure (231) and into the energy transfer structures (205). The directional energy-control elements (206) regulate the direction of electrical energy flow (702) through the energy transfer structures (205). Electrical energy is then transferred across the wireless energy transfer region (224) by electromagnetic induction to an opposing energy transfer structure (205), where the electrical energy passes through one of the directional energy-control elements (206) before being communicated to the energy transfer structure connection point (701) associated with the layered-graphene energy-storing housing (216). In the illustrated embodiment, the energy transfer structure connection point (701) is positioned within the layered-graphene energy-storing housing (216), where one or more energy transfer structure branch connections (405) distribute electrical energy throughout the layered-graphene energy-storing housing (216), which is configured to store and supply electrical energy. Other electrically conductive energy-storage materials and electrical energy transfer configurations capable of providing equivalent or superior electrical energy-storage and electrical energy transfer characteristics may likewise be employed while utilizing the principles described herein.

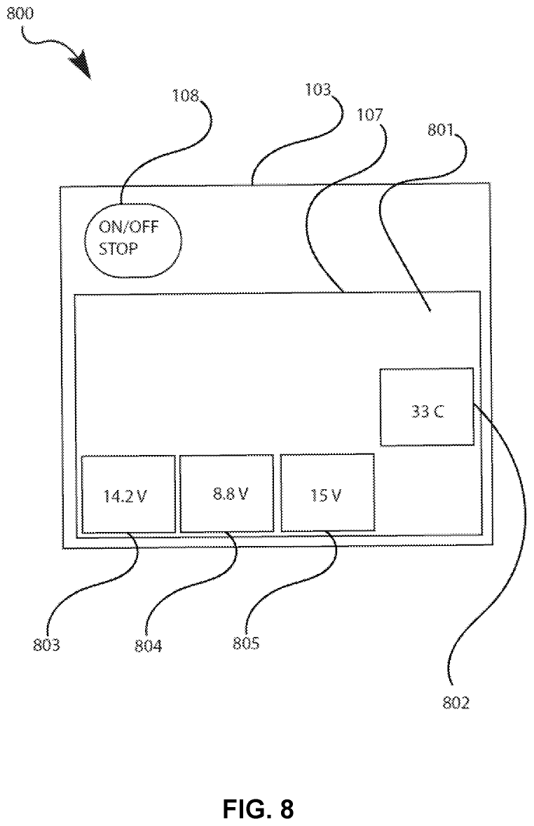

FIG. 8 illustrates one embodiment of the LCD computing device and diagnostic interface (800). In the illustrated embodiment, the LCD computing device (103) includes an LCD display screen (107) configured to display a diagnostic interface (801). The diagnostic interface (801) comprises diagnostic temperature information (802), electrical energy input (803), electrical energy output (804), stored electrical energy level (805), and other operational or diagnostic information associated with the High-Efficiency Electromagnetic Transducer (HEET). The LCD computing device (103) is electrically coupled through one or more electrical conductors (227, 228) to the internal switch (229), the diagnostic sensor (230), and associated system components to monitor system operation and communicate user control commands. The emergency stop on/off button (108) is electronically coupled to the internal switch (229) to selectively activate, deactivate, or interrupt operation of the High-Efficiency Electromagnetic Transducer (HEET). Although the illustrated embodiment utilizes an LCD computing device (103), other user-interface technologies capable of monitoring system operation, displaying diagnostic information, and receiving user input may likewise be employed while utilizing the principles described herein.

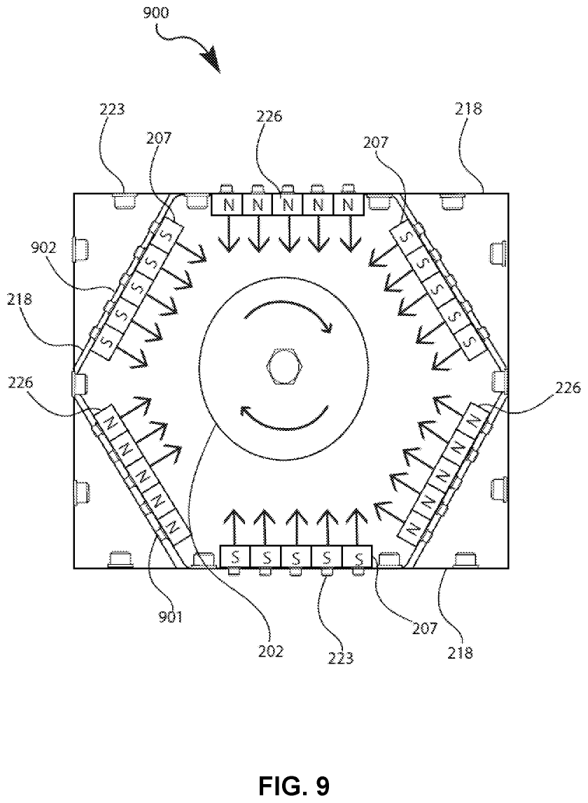

FIG. 9 illustrates one embodiment of the magnetic support assembly (900), including one or more magnetic arrays (207, 226) configured to provide magnetic support, electromagnetic induction, and rotational operation of the core assembly (202). In the illustrated embodiment, the magnetic support assembly (900) is compatible with both the magnetically levitated HEET assembly (200) and the magnetic ball bearing assembly configuration (500). The illustrated magnetic arrays (207, 226) are arranged in opposing polarity to establish opposing magnetic fields configured to facilitate magnetic support, controlled rotational movement of the core assembly (202), and electromagnetic induction. The electrically conductive structural support (218) is configured to maintain the positional relationship of the magnetic arrays (207, 226), provide structural integrity, and support electromagnetic operation of the High-Efficiency Electromagnetic Transducer (HEET). The magnetic arrays (207, 226) may comprise any suitable magnetic material, including permanent magnets, rare-earth magnets, ferrite magnets, alnico magnets, iron-nitride magnets, engineered magnetic materials, composite magnetic materials, metamaterials, and subsequently developed magnetic materials having equivalent or superior magnetic properties. The electrically conductive structural support (218) may be secured to the layered-graphene energy-storing housing (216) using one or more high-temperature structural fasteners (223), including tungsten fasteners or other thermally resistant fastening mechanisms. The magnetic arrays (207, 226) may be mechanically coupled to the electrically conductive structural support (218) by one or more mechanical coupling structures (901), or may be mechanically secured to, embedded within, or integrated into the electrically conductive structural support (218). In the illustrated alternative embodiment, one or more integrated magnetic arrays (902) are incorporated into the electrically conductive structural support (218).

The magnetic support assembly (900) represents the common magnetic support architecture utilized by the High-Efficiency Electromagnetic Transducer (HEET) in multiple embodiments. In the illustrated embodiments, the magnetic support assembly (900) comprises the magnetic arrays (207, 226), the electrically conductive structural support (218), and the associated magnetic components cooperatively arranged relative to the core assembly (202) and the layered-graphene energy-storing housing (216) to establish magnetic fields configured to facilitate magnetic support and electromagnetic induction. The magnetic support assembly (900) may be utilized with the magnetic levitation embodiment illustrated in FIG. 2 (200), the magnetic ball bearing embodiment illustrated in FIGS. 5 and 6 (500, 600), or other rotational support arrangements while utilizing the electrical energy-transfer architecture described herein.

The magnetic levitation assembly (200, 900) and the magnetic ball bearing assembly (500, 600, 900) described herein are illustrative embodiments of rotational support arrangements for the core assembly (202). Other rotational support arrangements capable of supporting rotational movement of the core assembly (202) while utilizing the electrical energy-transfer architecture described herein may likewise be employed without departing from the principles of the invention. Such rotational support arrangements may comprise magnetic, mechanical, fluid, pressurized-gas, hybrid, or other support configurations capable of supporting rotational movement of the core assembly (202) within the disclosed electrical energy-transfer architecture.

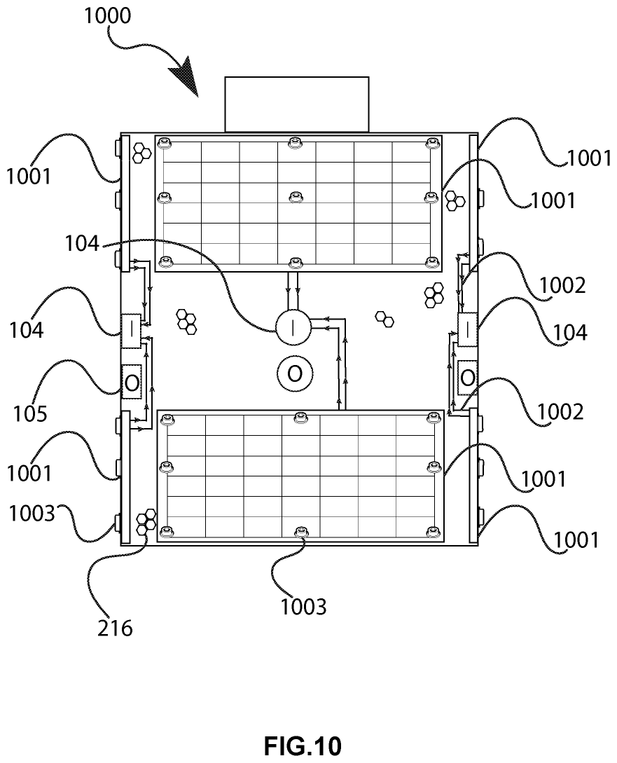

FIG. 10 illustrates an exterior side view of the High-Efficiency Electromagnetic Transducer (HEET) (1000) incorporating an optional thermal-energy harvesting embodiment. In the illustrated embodiment, a thermoelectric film (1001) is configured to convert thermal energy into electrical energy and is mechanically and thermally coupled to the layered-graphene energy-storing housing (216), with electrical conductors (1002) electrically coupled to one or more external power input connectors (104). Although the illustrated embodiment utilizes the layered-graphene energy-storing housing (216), other electrically conductive materials capable of providing equivalent or superior electrical energy-storage characteristics may likewise be employed. Electrical energy generated by the thermoelectric film (1001) may be supplied to the layered-graphene energy-storing housing (216), the High-Efficiency Electromagnetic Transducer (HEET), or both, to replenish stored electrical energy, supplement system operation, may improve overall system efficiency, extend operational duration, and recover a portion of thermal energy that would otherwise be dissipated. In preferred embodiments, the thermoelectric film (1001) is secured using high-temperature thermoelectric film fasteners (1003), including Inconel fasteners used in combination with Belleville washers, or other fastening systems configured to maintain clamping force and accommodate thermal expansion during prolonged operation at elevated temperatures.

One or more electrical conductors (1002) are electrically coupled to the thermoelectric film (1001) and configured to conduct electrical energy generated by the thermoelectric film (1001) to the High-Efficiency Electromagnetic Transducer (HEET) electrical system. In the illustrated embodiment, the electrical conductors (1002) are electrically coupled to one or more external power input connectors (104), thereby supplying recovered electrical energy to the layered-graphene energy-storing housing (216), the core assembly (202), or both. The recovered electrical energy may be utilized to replenish stored electrical energy, supplement system operation, extend system operating duration, improve overall system efficiency, or provide supplemental electrical energy for operation of the High-Efficiency Electromagnetic Transducer (HEET). In certain embodiments, the electrical conductors (1002) electrically couple the thermoelectric film (1001) to the external power input connector (104), permitting recovered electrical energy to be supplied to the High-Efficiency Electromagnetic Transducer (HEET) through the external power input interface.

In accordance with some embodiments, the thermoelectric film (1001) is configured to convert thermal energy into electrical energy and to supply the recovered electrical energy to the High-Efficiency Electromagnetic Transducer (HEET). In the illustrated embodiment, the recovered electrical energy is delivered through one or more electrical conductors (1002) to one or more external power input connectors (104), where the recovered electrical energy is introduced into the electrical energy transfer architecture for communication to the layered-graphene energy-storing housing (216), the core assembly (202), or both. The recovered electrical energy may be utilized to replenish stored electrical energy, offset operational electrical losses, supplement system operation, extend system operating duration, and improve overall electrical efficiency. In preferred embodiments, the thermoelectric film (1001) is mechanically secured using high-temperature thermoelectric film fasteners (1003), including Inconel fasteners used in combination with Belleville washers, or other fastening systems capable of maintaining clamping force while accommodating differential thermal expansion during prolonged operation at elevated temperatures.

Although preferred embodiments employ layered-graphene or graphene-based materials for the layered-graphene energy-storing housing (216), nanocrystalline alloy cores, advanced magnetic materials, and high-temperature structural materials, other electrically conductive materials, magnetically permeable materials, magnetic materials, structural materials, insulating materials, thermal-management materials, and components capable of providing equivalent or superior electrical, electromagnetic, thermal, mechanical, or operational characteristics may likewise be employed while utilizing the principles described herein.

While the foregoing written description enables one of ordinary skill in the art to make and use the invention, including what is presently considered to be the best mode of carrying out the invention, those of ordinary skill in the art will recognize that numerous modifications, variations, substitutions, combinations, and equivalent structures, materials, methods, and manufacturing techniques may be employed without departing from the scope or principles of the invention.

What is claimed is:

1. An electrical energy storage and power supply system, comprising:
(a) a housing comprising one or more electrically conductive materials, the housing being configured to store electrical energy and supply electrical energy for operation of the system and to one or more external electrical loads;
(b) a transducer core assembly disposed within the housing and configured to rotate, the transducer core assembly comprising a core and a conductive winding associated with the core;
(c) one or more magnetic arrays arranged relative to the transducer core assembly and configured to generate a magnetic field for electromagnetic induction;
(d) a chamber disposed within the housing, the transducer core assembly being disposed within the chamber;
(e) a magnetic levitation assembly configured to magnetically support the transducer core assembly within the chamber;
(f) one or more energy transfer structures configured to transfer electrical energy between the transducer core assembly and the housing; and
(g) one or more directional energy-control elements configured to regulate the direction of energy transfer through the energy transfer structures;
wherein the energy transfer structures are configured to transfer electrical energy between the transducer core assembly and the housing, and the directional energy-control elements are configured to regulate the direction of the electrical energy transfer.

2. An electrical energy storage and power supply system, comprising:
(a) a housing comprising one or more electrically conductive materials, the housing being configured to store electrical energy and supply electrical energy for operation of the system and to one or more external electrical loads;
(b) a transducer core assembly disposed within the housing and configured to rotate, the transducer core assembly comprising a core and a conductive winding associated with the core;
(c) one or more magnetic arrays arranged relative to the transducer core assembly and configured to generate a magnetic field for electromagnetic induction;
(d) a chamber disposed within the housing, the transducer core assembly being disposed within the chamber;
(e) one or more magnetic ball bearing assemblies configured to mechanically support the transducer core assembly while permitting rotational movement within the chamber;
(f) one or more energy transfer structures configured to transfer electrical energy between the transducer core assembly and the housing; and
(g) one or more directional energy-control elements configured to regulate the direction of energy transfer through the energy transfer structures;
wherein the one or more energy transfer structures and the one or more directional energy-control elements are configured to transfer electrical energy between the transducer core assembly and the housing.

3. The system of claim 1, wherein the magnetic levitation assembly comprises one or more magnetic arrays configured as a magnetic support assembly to magnetically support the transducer core assembly within the chamber.

4. The system of claim 2, wherein the one or more magnetic ball bearing assemblies comprise one or more magnetic ball bearing housings and one or more magnetic ball bearing support structures configured to mechanically support the transducer core assembly while permitting rotational movement within the chamber.

5. The system of claim 4, wherein the one or more magnetic ball bearing assemblies comprise a magnetic ball bearing support structure configured to receive the transducer core assembly and facilitate rotational movement thereof.

6. The system of claim 4, wherein at least a portion of the one or more magnetic ball bearing assemblies is mechanically coupled to the housing.

7. The system of claim 1 or claim 2, wherein the housing comprises a plurality of interlocking modular electrically conductive energy-storage housing sections configured to form the electrically conductive energy-storage housing.

8. The system of claim 1 or claim 2, further comprising an electrically conductive structural support, wherein one or more magnetic elements are supported by the electrically conductive structural support.

9. The system of claim 8, wherein the one or more magnetic arrays are configured to generate magnetic fields that induce electromagnetic induction within the core assembly.

10. The system of claim 9, wherein the one or more magnetic arrays are arranged to establish a magnetic flux path through the magnetically permeable core of the core assembly.

11. The system of claim 8, wherein the electrically conductive structural support comprises one or more electrically conductive materials selected from carbon-based materials, metallic materials, composite materials, nanomaterials, conductive polymers, or combinations thereof.

12. The system of claim 1 or claim 2, further comprising a valve assembly in fluid communication with the chamber and configured to regulate environmental conditions within the chamber.

13. The system of claim 12, wherein the valve assembly comprises a sealing structure configured to engage a gasket and a magnetic actuator configured to actuate a valve member.

14. The system of claim 1 or claim 2, further comprising a thermal buffer disposed between the ruggedized housing system and the electrically conductive energy-storage housing, the thermal buffer being configured to thermally isolate and protect the electrically conductive energy-storage housing.

15. The system of claim 1 or claim 2, further comprising a protective outer shell enclosing at least a portion of the housing.

16. The system of claim 1 or claim 2, further comprising one or more interconnection interfaces configured to electrically connect the system with one or more additional systems.

17. The system of claim 1 or claim 2, wherein the housing comprises one or more external power input connectors configured for electrical coupling to one or more external power sources.

18. The system of claim 1 or claim 2, further comprising a control system configured to monitor and control operation of the system.

19. The system of claim 18, wherein the control system comprises one or more sensors configured to provide operational data for monitoring operation of the system.

20. The system of claim 1 or claim 2, wherein the core assembly comprises one or more electrically insulating materials and at least one core conductive winding.

21. The system of claim 1 or claim 2, further comprising one or more thermal-energy harvesting devices configured to recover thermal energy associated with operation of the system and convert the recovered thermal energy into electrical energy for use by the system.

22. The system of claim 1 or claim 2, wherein the system is configured to be deployed individually or as part of a multi-unit architecture.
